(19) United States
(12) Patent Application Publication
(10) Pub. No.: US 2026/0070460 A1
(43) Pub. Date: Mar. 12, 2026

(54) VEHICLE BATTERY CHARGING PLANNING SYSTEM

(71) Applicant: TOYOTA JIDOSHA KABUSHIKI KAISHA, Toyota-shi (JP)

(72) Inventor: Yuuki OKADA, Iwata-shi (JP)

(73) Assignee: TOYOTA JIDOSHA KABUSHIKI KAISHA, Toyota-shi (JP)

(21) Appl. No.: 19/257,716

(22) Filed: Jul. 2, 2025

(30) Foreign Application Priority Data
Sep. 12, 2024 (JP) 2024-158258

(51) Int. Cl. B60L 53/67; B60L 53/16; B60L 53/65; B60L 53/68; B60L 55/00

(52) U.S. Cl. CPC B60L 53/67; B60L 53/65; B60L 53/68; B60L 55/00; B60L 53/16; B60L 2240/62

(57) ABSTRACT

The determination server configuring the vehicle battery charging planning system determines whether each battery electric vehicle can respond to a demand response request from the electric power company based on the vehicle information regarding the charge status of the vehicle battery of each battery electric vehicle and the user setting set by the user of each battery electric vehicle. The determination server extracts a plurality of target vehicles so as to exclude battery electric vehicle determined to be unable to respond to the demand response request, and transmits the plurality of target vehicles to the charging plan calculation server that configures the vehicle battery charging planning system. The charging plan calculation server formulates a charging plan targeting the plurality of extracted target vehicles, and transmits the charging plan to the charging command server.

### CROSS-REFERENCE TO RELATED APPLICATION

This application claims priority to Japanese Patent Application No. 2024-158258 filed on Sep. 12, 2024. The disclosure of the above-identified application, including the specification, drawings, and claims, is incorporated by reference herein in its entirety.

### BACKGROUND

### 1. Technical Field

The present disclosure relates to a vehicle battery charging planning system.

### 2. Description of Related Art

Japanese Unexamined Patent Application Publication No. 2020-018104 (JP 2020-018104 A) discloses a charge management device capable of managing charge for a plurality of battery electric vehicles (hereinafter, referred to as EVs) under a constraint condition based on power supply capability. The charge management device calculates charge schedules for the EVs and limits the number of EVs that can be charged at the same time while considering the constraint condition. In this way, the charge management device can charge the EVs within the range of the constraint condition.

### SUMMARY

Since the charge management device calculates charge schedules that can correspond to the constraint condition for all the EVs with EV charge notifications sent from users of the EVs, the processing load on the charge management device tends to be high, and the response to the constraint condition tends to be slow.

Means for addressing the above issue and their functions and effects will be described below.
In order to address the above issue, an aspect provides a vehicle battery charging planning system configured to
determine whether each battery electric vehicle is able to respond to a demand response request from an electric power company based on vehicle information relating to a charging state of the vehicle battery of the battery electric vehicle and user setting made by a user of the battery electric vehicle.
The vehicle battery charging planning system extracts a plurality of target vehicles so as to exclude the battery electric vehicle determined not to be able to respond to the demand response request.
The vehicle battery charging planning system makes a charging plan for the extracted target vehicles.

The above vehicle battery charging planning system can make a charging plan for only battery electric vehicles capable of responding to a demand response request.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a charging system including a vehicle battery charging planning system according to an embodiment;

FIG. 2 is a configuration diagram of a determination server that configures a vehicle battery charging planning system according to the embodiment;

FIG. 3 is a configuration diagram of a charging plan calculation server that configures a vehicle battery charging planning system according to the embodiment;

FIG. 4 is a sequence diagram illustrating a flow of a process of planning a charging plan by the vehicle battery charging planning system according to the embodiment; and

FIG. 5 is a flowchart illustrating a flow of a process of extracting a target vehicle by the determination server in the embodiment.

### DETAILED DESCRIPTION OF EMBODIMENTS

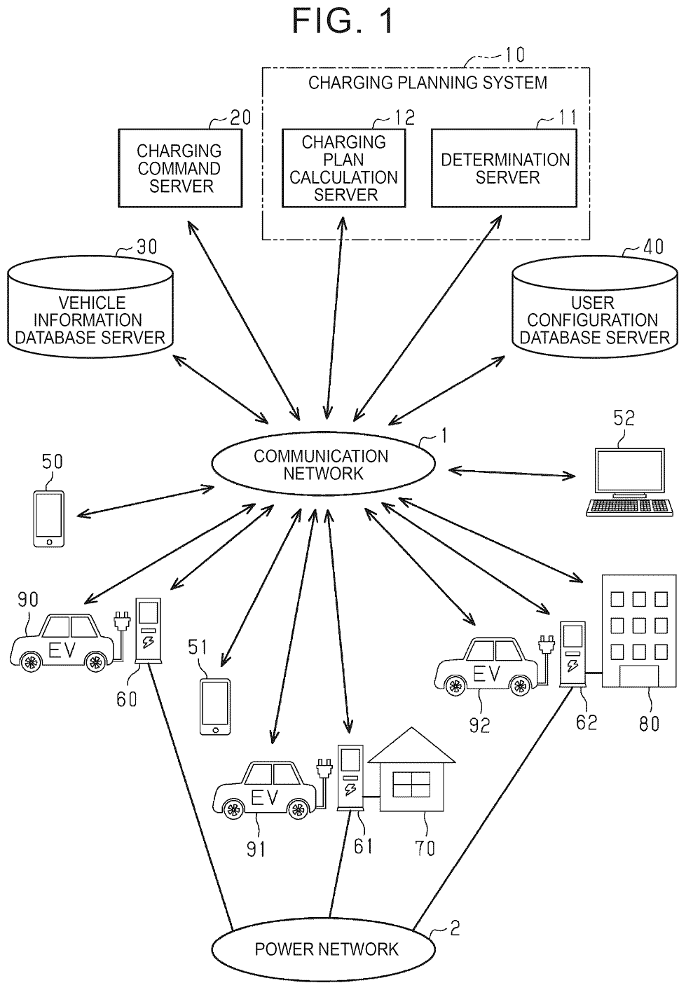

Hereinafter, an embodiment of a vehicle battery charging planning system 10 will be described with reference to FIGS. 1 to 5.

### Overview of the Configuration of the Charging System

First, an outline of a configuration of a charging system will be described. As illustrated in FIG. 1, the charging system includes a charging planning system 10, a charging command server 20, a vehicle information database server 30, a user setting database server 40, user-side terminal devices 50 to 52, charging devices 60 to 62, and battery electric vehicle 90 to 92. These apparatuses are configured to be able to communicate with each other via the communication network 1.

Charging devices 60 through 62 are powered by the utility via power network 2 and charge 92 from battery electric vehicle 90. The charging device 60 is provided in a charging station. The charging device 61 is provided at the user's home 70. The charging device 62 is provided in the office 80.

The user-side terminal devices 50 to 52 are communicably connected to battery electric vehicles 90 to 92. In FIG. 1, portable terminal devices 50 and 51 and a terminal device 52, which is a personal computer, are shown as examples of the user-side terminal devices 50 to 52. The user-side terminal devices 50 to 52 can set the target SOC, the departure time, the intention to participate in DR, and the like for the corresponding battery electric vehicles 90 to 92. DR intent is an indication of the user's intent to accept charge control to respond to the demand response request.

Battery electric vehicles 90 to 92 includes vehicle batteries, a vehicle ECU, a communication device, and a GPS receiver. Battery electric vehicles 90 to 92 can be charged with electric power supplied from the outside of the vehicle, and the electric power of the vehicle batteries can be outputted to the outside of the vehicle. GPS receiver allows the position of the vehicles to be ascertained in real time. The vehicle ECU can manage vehicle data. The vehicle information includes plug connection information indicating whether or not the plug is connected to the charging devices 60 to 62, a SOC remaining capacity indicating the current remaining vehicle battery level, location information indicating the current position of the vehicle, a charging state indicating a state such as starting, stopping, ending, and halfway of charging, a communication abnormal state, and the like. The communication device can receive a command from a user or transmit vehicle information to the outside.

The vehicle information database server 30 stores vehicle information. The vehicle information database server 30 updates the stored information according to the update of the vehicle information. The user setting database server 40 stores user setting data such as target SOC, departure time, and DR participation intention. The user setting database server 40 updates the stored setting data each time the user updates the setting data.

The charging planning system 10 is configured to include a determination server 11 and a charging plan calculation server 12. The determination servers 11 extract the target vehicles to be subjected to the charge planning from among the plurality of battery electric vehicles 90 to 92. The charging plan calculation server 12 formulates a charging plan for the extracted target vehicle. The charging command server 20 transmits a charging/discharging command such as starting, pausing, and ending of charging/discharging from the corresponding battery electric vehicle 90 to 92 in accordance with the charging plan formulated by the charging planning system 10, and executes the charging plan.

### Functional Configuration of the Determination Server 11

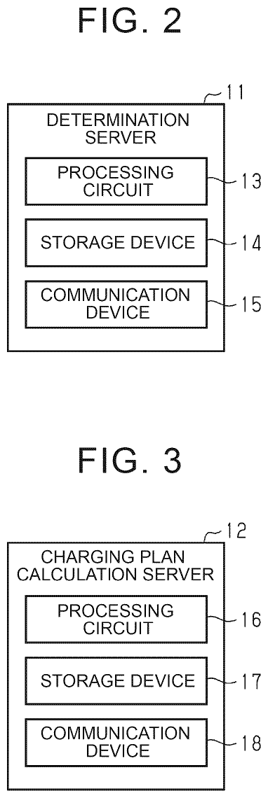

FIG. 2 is a configuration diagram illustrating a functional configuration of the determination server 11. As illustrated in FIG. 2, the determination server 11 includes a processing circuit 13, a storage device 14, and a communication device 15. The respective functional configurations are realized by CPU reading out a program stored in ROM and executing the program using RAM as a working area. The communication device 15 is an interface for communicating with the outside via the communication network 1. The storage device 14 stores information about 92 vehicles and user setting data from a plurality of battery electric vehicle 90. The processing circuit 13 determines, based on the vehicle information and the user setting data stored in the storage device 14, the target vehicle that can respond to the demand response request from the electric power company from the plurality of battery electric vehicles 90 to 92.

### Functional Configuration of the Charging Plan Calculation Server 12

FIG. 3 is a configuration diagram illustrating a functional configuration of the charging plan calculation server 12. As illustrated in FIG. 3, the charging plan calculation server 12 includes a processing circuit 16, a storage device 17, and a communication device 18. The respective functional configurations are realized by CPU reading out a program stored in ROM and executing the program using RAM as a working area. The communication device 18 is an interface for communicating with the outside via the communication network 1. The processing circuit 16 formulates a charging plan for the target vehicle capable of responding to the demand response request from the electric power company. The storage device 17 stores a charging plan for the target vehicle.

### Operation of Embodiment

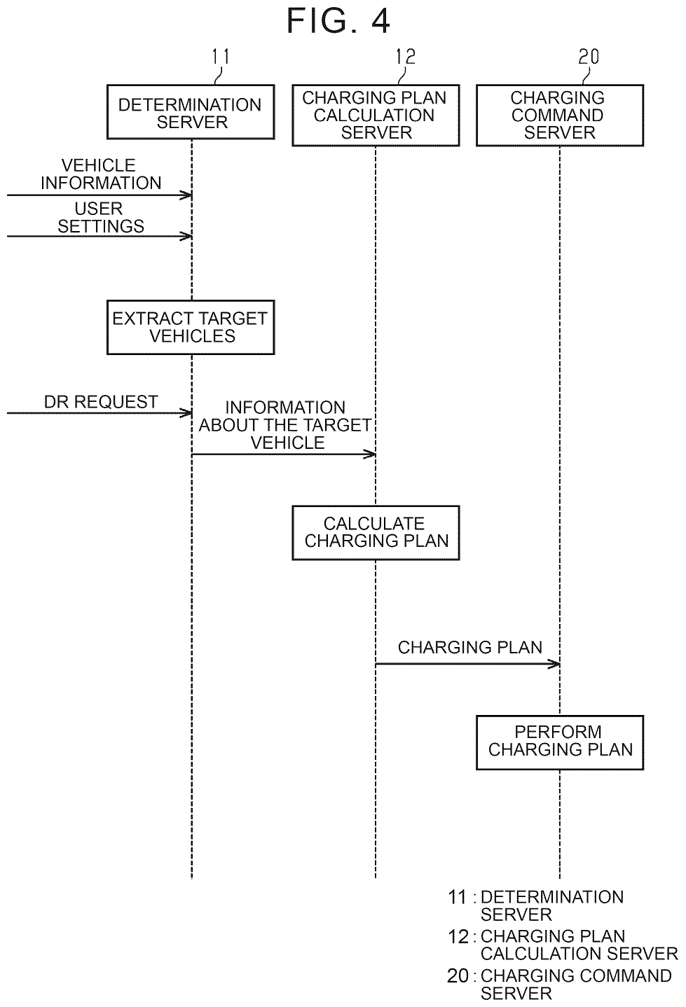

Next, the operation of the embodiment will be described with reference to FIG. 4. As illustrated in FIG. 4, the determination server 11 acquires the vehicle information of 92 from the plurality of battery electric vehicle 90 from the vehicle information database server 30. Further, the determination server 11 acquires the user setting data of 92 from the plurality of battery electric vehicle 90 from the user setting database server 40.

Next, the determination server 11 extracts the target vehicle to be subjected to the charge planning so as to exclude the vehicle that cannot respond to the demand response request, based on the vehicle information and the user setting data about 92 from the respective battery electric vehicle 90. After that, when the communication device 15 receives the demand response request, the determination server 11 transmits the extracted information about the target vehicle to the charging plan calculation server 12.

The charging plan calculation server 12 calculates a charging plan for the target vehicle extracted by the demand response request and the determination server 11, and transmits the charging plan to the charging command server 20. The charging command server 20 transmits a charge/discharge command from battery electric vehicle 90 to the target vehicles among the target vehicles 92. The target vehicle that has received the charging command controls the charging device in accordance with the charging command, and executes the charging plan. For example, when battery electric vehicle 90 is the target vehicle, battery electric vehicle 90 controls the charging device 60 to execute the charging planning.

### Flow of Processing for Extracting the Target Vehicle by the Determination Server 11

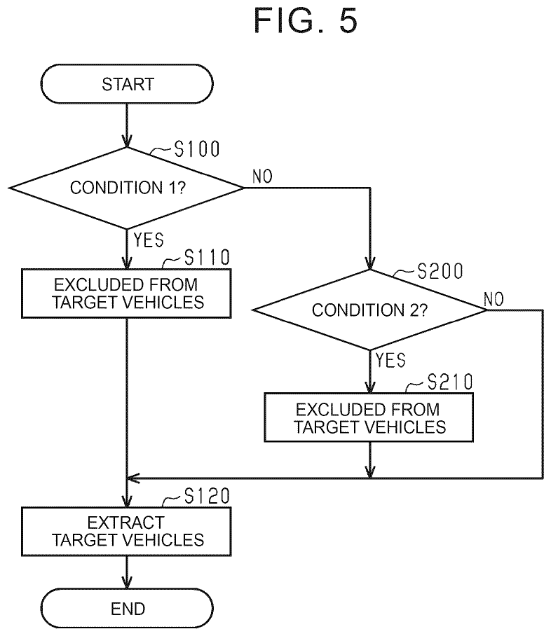

Hereinafter, a process of extracting a target vehicle by the determination server 11 will be described with reference to FIG. 5. Upon receiving the demand response request, the determination server 11 starts a series of processes illustrated in FIG. 5. First, in S100, it is determined whether each of the plurality of battery electric vehicles 90 to 92 satisfies the condition 1. Condition 1 is a condition for determining whether or not each of the battery electric vehicles 90 to 92 can respond to a demand response request based on the vehicle information and the user setting data of each of the battery electric vehicles 90 to 92. When the condition 1 is satisfied, the determination server 11 determines that battery electric vehicle cannot respond to the demand response request.

The determination server 11 determines that the condition 1 is satisfied by satisfying any one of the following three conditions.
Plug connection information is not connected.
The location information is not the home 70 or the office 80.
The intention to participate in DR cannot be confirmed.

That is, when the plug-connection information is not connected, the determination server 11 determines that it is not possible to respond to the demand response request when the location information is neither the home 70 nor the office 80, or when it satisfies any of the cases where the intention to participate in DR cannot be confirmed. An example of a state in which the intention to participate in DR cannot be confirmed is a state in which the intention to participate in DR is not obtained from the user setting database server 40. Another condition in which DR participation intention cannot be confirmed is that the user does not intend to respond to the demand response request, and the user does not indicate DR participation intention.

If it is determined in S100 that the condition 1 is satisfied (S100: YES), the process proceeds to S110. In S110, battery electric vehicle determined to satisfy the condition 1 is excluded from the target vehicles to be subjected to the charge planning. Next, the process proceeds to S120, and battery electric vehicle determined to satisfy the condition 1 is excluded in S120 to extract the target vehicles, and the process ends.

On the other hand, when determining in S100 that the above condition 1 is not satisfied (S100: NO), the determination server 11 advances the process to S200. In S200, the determination server 11 determines whether or not the condition 2 is satisfied based on battery electric vehicle information and the user setting data. Condition 2 is not excluded in Condition 1, but is a condition for determining that it is not possible to respond to a demand response request due to another cause such as not actually there is a demand for charging or there is no margin for adjustment of charging.

The determination server 11 determines that the condition 2 is satisfied by satisfying any one of the following three conditions. When the condition 2 is satisfied, the determination server 11 determines that the vehicle cannot respond to the demand response request.
SOC remaining capacity has reached the target SOC.
The battery is charged while it is being charged.
Time to departure time is less than 6 hours.

That is, the determination server 11 determines that the demand response request cannot be handled when SOC remaining capacity has reached the target SOC, when the state of charge is in the middle of being charged, or when any of the cases where the time until the departure time is less than six hours is satisfied.

When determining in S200 that the vehicle satisfies the condition 2 (S200: YES), the determination server 11 advances the process to S210 to exclude the vehicle from the target vehicle in S210. Next, the process proceeds to S120, the target vehicles are extracted in S120, and the process ends.

If it is determined in S200 that the condition 2 is not satisfied (S200: NO), the determination server 11 advances the process to S120, extracts the target vehicles in S120, and ends the process. In this case, any vehicle is extracted as the target vehicle without being excluded.

Operation of this Embodiment

The vehicle battery charging planning system 10 determines whether or not each battery electric vehicles 90 to 92 can respond to a demand response request from an electric power company based on vehicle information relating to the charge status of the vehicle battery of each battery electric vehicles 90 to 92 and user settings set by the user of each battery electric vehicles 90 to 92. The vehicle battery charging planning system 10 extracts a plurality of target vehicles so as to exclude a battery electric vehicle determined to be unable to respond to the demand response request. The vehicle battery charging planning system 10 formulates a charging plan for the plurality of extracted target vehicles.

In this way, the vehicle battery charging planning system 10 can plan the charge planning for only battery electric vehicle that can respond to the demand response request.

Effect of this Embodiment

(1) The vehicle battery charging planning system 10 calculates a charge planning for only a battery electric vehicle that can respond to a demand response request from among the plurality of battery electric vehicles 90 to 92. Therefore, the vehicle battery charging planning system 10 can reduce the amount of data to be processed and the amount of data to be transmitted and received in order to formulate a charging plan.

As described above, the vehicle battery charging planning system 10 reduces the processing load required for calculating the charging plan, and can quickly respond to the demand response request.

(2) The vehicle battery charging planning system 10 includes a determination server 11 that determines whether or not battery electric vehicles 90 to 92 can respond to a demand response request from an electric power company based on vehicle information and user settings, and extracts a plurality of target vehicles so as to exclude a battery electric vehicle determined to be unable to respond to the demand response request. The vehicle battery charging planning system 10 includes a charging plan calculation server 12 that plans a charging plan for a plurality of target vehicles extracted by the determination server 11.

The charging plan calculation server 12 calculates a charge plan for only battery electric vehicle that can respond to the demand response request extracted by the determination server 11. Therefore, it is possible to reduce the amount of data to be processed and the amount of data to be transmitted and received by the charging plan calculation server 12. Therefore, the vehicle battery charging planning system 10 can reduce the processing load of the charging plan calculation server 12 related to the calculation of the charging plan and improve the responsiveness to the demand response request.

(3) In the vehicle battery charging planning system 10, it is determined whether or not the respective battery electric vehicles 90 to 92 are connected to the corresponding charging devices 60 to 62. Then, it is determined that battery electric vehicle not connected to the plugs of the charging devices 60 to 62 cannot respond to the demand response request from the electric power company.

The vehicle battery charging planning system 10 calculates a charging plan for only battery electric vehicle connected to the plugs 62 from the charging devices 60 to 92 from the plurality of battery electric vehicle 90. Therefore, it is possible to exclude a battery electric vehicle in which the intention of charging is not made. Therefore, the vehicle battery charging planning system 10 can exclude a battery electric vehicle that does not actually intend to charge the battery from the charge planning, and can formulate an efficient charge planning.

(4) The vehicle battery charging planning system 10 determines whether or not the location of battery electric vehicles 90 to 92 is the home 70 or the office 80. Then, in a battery electric vehicle where the locations are not the home 70 or the office 80, it is determined that it is not possible to respond to a demand response request from the electric power company.

The vehicle battery charging planning system 10 calculates a charge planning for only a battery electric vehicle in which the locations are the home 70 or the office 80 among the plurality of battery electric vehicle. Therefore, only battery electric vehicle that can be actually charged at the home 70 or the business office 80 in the charging plan can be targeted, and vehicles that are less likely to be charged can be excluded from the charging plan. Accordingly, the vehicle battery charging planning system 10 can formulate a more accurate and efficient charging plan.

(5) The vehicle battery charging planning system 10 determines that the demand response request from the electric power company cannot be handled in a battery electric vehicle where the intention to participate in the demand response is not indicated in the user setting data.

The vehicle battery charging planning system 10 excludes vehicles that do not agree to participate in the demand response from the charging planning. Therefore, it is possible to formulate an efficient charging plan for only a vehicle that actually responds to the demand for demand response. Therefore, the vehicle battery charging planning system 10 can realize the charging operation according to the intention of the user.

(6) The vehicle battery charging planning system 10 determines that battery electric vehicle where SOC remaining capacity has reached the target SOC cannot respond to the demand response request from the electric power company.

In battery electric vehicle where SOC remaining capacity has reached the target SOC, there is no need to formulate a charge planning again. The vehicle battery charging planning system 10 excludes a battery electric vehicle where SOC remaining capacity has reached the target SOC from the target vehicle to be subjected to the charge planning. As a result, the processing load required for calculating the charging plan can be further reduced.

(7) The vehicle battery charging planning system 10 determines that battery electric vehicle in which the vehicle state is in the charging state during the charging cannot respond to a demand response request from the electric power company.

If charging is interrupted during charging, the vehicle battery may deteriorate quickly. The vehicle battery charging planning system 10 excludes a battery electric vehicle in which the vehicle state is in a charging state during charging from the target vehicle to be subjected to the charging planning. As a result, it is possible to prevent frequent start and stop of charging, thereby suppressing deterioration of the vehicle battery and enabling the vehicle battery to be used for a longer period of time.

(8) The vehicle battery charging planning system 10 determines that the demand response request from the electric power company cannot be handled for a battery electric vehicle in which the time to the departure time is less than six hours in the user setting data.

When the time to the departure time is less than 6 hours, it is difficult to adjust the charge plan in response to the demand response request, and there is a possibility that the charge control in response to the demand response request cannot be realized. The vehicle battery charging planning system 10 excludes a battery electric vehicle in which the time until the departure time is less than 6 hours from the target vehicle to be subjected to the charging planning. As a result, a vehicle having room for adjusting the charging plan can be used as the target vehicle.

### Example of Change

The present embodiment can be modified as follows. The present embodiment and the following modifications can be implemented in combination with each other within a technically consistent range.

In the embodiment, the vehicle battery charging planning system 10 includes a determination server 11 for extracting a target vehicle and a charging plan calculation server 12 for planning a charging plan for the target vehicle. The vehicle battery charging planning system 10 may be configured by integrating the determination server 11 and the charging plan calculation server 12 into a single server.

In the embodiment, the condition 1 and the condition 2 are described separately, but the condition 1 and the condition 2 may be interchanged with each other within a range not technically inconsistent. For example, it may be changed to the condition 2 that the intention to participate in DR is not made, or it may be changed to the condition 1 that the remaining SOC capacity has reached the target SOC.

In embodiments, both Conditions 1 and 2 are described by way of example only, but should be understood to include all situations in which it is not possible to respond to demand for a demand response. For example, in a case where the communication state is abnormal, in a case where the charging plan of the vehicle being used by the user is already set, in a case where the technical requirement for responding to the demand response request is not satisfied, and the like can be cited.

What is claimed is:

1. A vehicle battery charging planning system that makes a charging plan for a plurality of battery electric vehicles, the vehicle battery charging planning system being configured to:
determine whether each battery electric vehicle is able to respond to a demand response request from an electric power company based on vehicle information relating to a charging state of a vehicle battery of the battery electric vehicle and user setting made by a user of the battery electric vehicle;
extract a plurality of target vehicles so as to exclude the battery electric vehicle determined not to be able to respond to the demand response request; and
make a charging plan for the extracted target vehicles.

2. The vehicle battery charging planning system according to claim 1, comprising:
a determination server that determines whether each battery electric vehicle is able to respond to the demand response request based on the vehicle information and the user setting, and extracts a plurality of target vehicles so as to exclude the battery electric vehicle determined not to be able to respond to the demand response request; and
a charging plan calculation server that makes a charging plan for the target vehicles extracted by the determination server.

3. The vehicle battery charging planning system according to claim 1, wherein
the vehicle battery charging planning system determines whether each battery electric vehicle is connected to a plug of a charging device as the vehicle information, and determines that the battery electric vehicle that is not connected to the plug of the charging device is not able to respond to the demand response request.

4. The vehicle battery charging planning system according to claim 1, wherein
the vehicle battery charging planning system determines whether the battery electric vehicle is located at a personal residence or a business place as the vehicle information, and determines that the battery electric vehicle that is not located at a personal residence or a business place is not able to respond to the demand response request.

5. The vehicle battery charging planning system according to claim 1, wherein the vehicle battery charging planning system determines that the battery electric vehicle that does not indicate an intention to participate in a demand response in the user setting is not able to respond to the demand response request.
